(19) United States
(12) Patent Application Publication
(10) Pub. No.: US 2005/0052002 A1
(43) Pub. Date: Mar. 10, 2005

(54) Airbag module and cover

(75) Inventors: Shinji Hayashi, Echi-gun (JP); Masaru Morita, Moriyama-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/890,256

(22) Filed: Jul. 14, 2004

(30) Foreign Application Priority Data
Sep. 4, 2003 (JP) 2003-313310

(51) Int. Cl. B60R 21/20

(52) U.S. Cl. 280/728.3

(57) ABSTRACT

An airbag cover is provided with a tear line, an open-out door panel which is openable when the tear line is torn, a thinned portion formed in the boundary area between the main body of the airbag cover and the open-out door panel on the back surface of the cover, and a second rib extending in the direction intersecting the extending surface of the open-out door panel between the main body of the airbag cover and the open-out door panel. The airbag cover is configured such that the extending length of the portion on which the second rib is provided is larger than the wall thickness of the respective portions on the side of the open-out door panel with respect to the second rib.

### BACKGROUND

The present invention relates to a technology for configuring an airbag cover for covering a vehicle's airbag.

In an airbag apparatus to be mounted to a vehicle, an airbag cover for covering an airbag is provided. A configuration generally referred to as an airbag cover of this type is provided, for example, with a linear groove or tear line on the inner wall surface of the airbag cover. This airbag cover is torn along the tear line upon collision of the vehicle, so as to allow deployment and inflation of the vehicle's airbag toward the outside of the airbag cover.

In the above-described configuration, there is a need to enhance the tearing of the airbag cover along the tear line upon deployment and inflation of the vehicle's airbag in which the airbag cover is torn along the tear line and the torn portion to be deployed smoothly.

### SUMMARY

An object of the present invention is to provide a viable technology for configuring an airbag cover used to cover a vehicle's airbag and a technology relating thereto. The present invention achieves this object. The present invention provides a technology which can be applied to motor vehicles and other various vehicles such as trains, motorbikes (saddle-type vehicles), airplanes, boats, etc.

In a first embodiment of the present invention, there is a configuration of an airbag cover for covering a vehicle's airbag from the cabin side. The vehicle's airbag according to the first embodiment of the present invention is adapted to protect an occupant by being deployed and inflated toward an occupant protecting area upon collision of the vehicle.

The airbag cover of the first embodiment of the present invention is provided with at least a linear groove, an open-out door, and hinge mechanism.

The linear groove is a linearly formed groove having a depth within the limit of the wall thickness of the airbag cover. The linear groove may be formed on a molded member by after-processing (processing performed by laser processing equipment) by laser cut. The groove is a portion having a smaller wall thickness with respect to the respective portions of the airbag cover, along which the airbag cover is torn when the vehicle's airbag is deployed and inflated, and is referred to as a tear line.

The open-out door is a door adapted to be opened out upon tearing of the linear groove in association with deployment and inflation of the vehicle's airbag.

The hinge mechanism functions to enable an opening action of the open-out door toward the cabin. In an exemplary embodiment, the hinge mechanism is formed in the area connecting one end and the other end of the linear groove.

Particularly in the present invention, the hinge mechanism may have extending portions. The extending portions have a configuration that extends in the direction intersecting the extending surface of the open-out door between the main body of the airbag cover and the open-out door. In some embodiments of the invention, the extending portion may include a projecting portion projecting from the main body of the airbag cover in the direction intersecting the extending surface of the open-out door and the main body of the airbag cover at the position corresponding to the projecting portion. This extending portion may be integral with the main body of the airbag cover, or may be a separate piece from the main body of the airbag cover. In configurations according to this latter embodiment, the extending portion may be adhered to the airbag cover via an adhesive or a mechanical connector or a friction fit, or may simply be present on the airbag cover (e.g., the extending portion could lie in a groove on a component other than the airbag cover and once the airbag cover positioned in place to be operational, the extending portion then interfaces with the airbag cover). The extending portion may extends in the direction intersecting the extending surface of the open-out door in a matter so that the portion extends in a state of extending in the direction orthogonal to the extending surface of the open-out door, and hence includes not only a state of extending in the direction orthogonal to the extending surface of the open-out door, but also a state of extending in the direction oblique to the extending surface of the open-out door.

Also, in the present invention, the extending length of the extending portion is configured to have a larger wall thickness than the respective portions on the side of the open-out door with respect to the extending portion. The respective portions on the side of the open-out door may include the open-out door and the boundary area between the open-out door and the extending portion. Typically, the extending length of the extending portion is defined by the height of the projecting portion projecting from the main body of the airbag cover in the direction intersecting the extending surface of the open-out door and the wall thickness of the main body of the airbag cover at the position corresponding to the projecting portion.

With a configuration of the airbag cover according to the first embodiment of the present invention, a viable construction of the airbag cover for covering the vehicle's airbag is achieved.

Accordingly, in the first embodiment of the present invention, the position of the hinge for opening the open-out door may be clearly defined by the extending portion provided between the main body of the airbag cover and the open-out door configured as described above. This is because the hinge may be formed exactly at the designed position, limiting or preventing the possibility that the position of the hinge is formed at an unexpected position as a result of generation of bending force in the boundary area between the hinge mechanism and the open-out door. In addition, since the load applied to the position of the hinge when the vehicle's airbag is deployed and inflated and hence the open-out door is opened can be received by the extending portion having a large wall thickness, the strength of the airbag cover can be increased.

In addition to the configuration of the airbag cover according to the first embodiment of the present invention, a second embodiment of the present invention includes an airbag cover that is configured such that the wall thickness of the open-out door at the portion continuing from the extending portion is thinned with respect to the wall thickness at other portions of the open-out door. In other words, the airbag cover is formed with a thinned portion at the portion corresponding to the root of the open-out door.

With such a configuration of the airbag cover according to this second embodiment, by cooperation of the extending portion and the thinned portion, the position of the hinge of the open-out door can be positively formed at the thinned portion between the extending portion and the open-out door, and the position of the hinge when the open-out door opens can be clearly defined. Also, since the open-out door can easily be bent at the thinned portion between the extending portion and the open-out door, a hinge effect can be improved.

According to a third embodiment of the present invention, the airbag cover is further configured such that a storage member for storing the vehicle's airbag and the airbag cover are joined with each other. When joined (in such a joint), the extending portion is configured as a joint rib to be abutted against and joined to the storage member.

The storage member includes a member having a configuration in which the vehicle's airbag can be stored, and a configuration of the storage member includes a state in which the member joined to the airbag cover stores the vehicle's airbag, a state in which a member for storing the vehicle's airbag is attached to and detached from a member joined to the airbag cover, and so on. Typically, a configuration in which a bracket member having a leg member is joined to the airbag cover, and the member for storing the vehicle's airbag (retainer) can be attached to and detached from the leg member can be employed. In this case, the storage member may be formed of a bracket member having a leg member and the retainer with the vehicle's airbag stored therein.

In addition to the configuration in which the storage member by itself has a function to store the vehicle's airbag independently, a configuration in which the storage member stores the vehicle's airbag partly or entirely as a result of attachment of the retainer with the vehicle's airbag stored therein to the storage member via a bracket or the like is also included in the scope of the storage member. More specifically, the member having the leg member to which the retainer with the vehicle's airbag stored therein can be attached via the bracket or the like and defining a space for storing the retainer with the leg member is a typical example of the storage member. In a state in which the retainer is stored in the storage space of the storage member, the vehicle's airbag is consequently stored in the storage space. It is noted here that the extending portion described above may be attached to the storage member instead of or in addition to the airbag cover. Still further, the extending member may be separate from the storage member.

With such a configuration of the airbag cover according to the third embodiment of the present invention, the portion corresponding to the root of the open-out door is positively fixed to the storage member side via the extending portion, and hence opening action of the open-out door can be carried out smoothly as designed. Among others, when the extending portion is used as a joint rib in the configuration of the second embodiment of the present invention, cooperation of the extending portion, which serves as the joint rib, and the thinned portion can smoothen the opening action of the open-out door.

According to a fourth embodiment of the present invention there is a configuration of an airbag module that includes a vehicle's airbag, a storage member for storing the vehicle's airbag, gas feeding mechanism for feeding inflation gas to the vehicle's airbag, and the airbag cover, which may be substantially the same as that of the first embodiment, and is mounted to a vehicle in block of the airbag module. In some variations of this embodiment (and other embodiments) the airbag module is provided with a member on which the airbag cover is disposed, that is, a panel so-called an instrument panel.

Therefore, with such a configuration of the airbag module according to the fourth embodiment, the position of the hinge may be formed exactly at the position as designed when opening the open-out door for allowing the vehicle's airbag to be deployed and inflated upon collision of the vehicle avoiding the position of the hinge to be formed at an unexpected position as a result of generation of forced bent in the boundary area between the hinge mechanism and the open-out door. Also, since the load applied to the position of the hinge, which is generated when the vehicle's airbag is deployed and inflated, and hence the open-out door is opened, can be received by the extending portion, which has a larger wall thickness, the strength of the airbag cover can be achieved.

In a fifth embodiment of the present invention, there is an airbag module that is configured such that the wall thickness of the portion between the extending portion and the open-out door is thinned to the wall thickness smaller than that of the open-out door. In other words, the airbag cover is formed with a thinned portion on the side of the open-out door with respect to the extending portion.

According to the configuration of the airbag module of the fifth embodiment, by the cooperation of the extending portion of the thinned portion, the position of the hinge can be formed positively at the thinned portion between the extending portion and the open-out door, and in addition, since the open-out door can be bent easily at the position of the hinge, the effect of the hinge increases.

In yet another embodiment of the present invention, the airbag module is configured such that the storage member for storing the vehicle airbag and the airbag cover are joined with each other. When joined (in such joint), the extending portion abuts against the storage member and is used as the joint rib.

In this embodiment, since the portion corresponding to the root of the open-out door is positively fixed via the extending portion, the opening action of the open-out door can be smoothened as designed. Among others, when the extending portion is used as the joint rib in the configuration of the fifth embodiment of the invention, the opening action of the open-out door can be smoothen by the cooperation of the extending portion, which serves as joint rib, and the thinned portion.

As described above, according to an embodiment of the present invention, by devising the configuration of the hinge mechanism for allowing the opening action of the open-out door, a viable technology for configuring the airbag cover for covering the vehicle's airbag and an airbag module provided with the airbag cover is realized.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view showing a state of the airbag cover according to an embodiment the present embodiment when viewed from the back surface of the cover.

FIG. 2 is a top view of the portion in the vicinity of the tear line in FIG. 1.

FIG. 3 is an enlarged view of a portion A in FIG. 2.

FIG. 4 is a drawing showing a cross-sectional configuration taken along the line B-B in FIG. 3.

FIG. 5 is a drawing showing a cross-sectional configuration taken along the line C-C in FIG. 3.

FIG. 6 is a drawing showing a cross-sectional configuration taken along the line D-D in FIG. 3.

FIG. 7 is a cross-sectional view of an airbag module showing a state in which the airbag cover 100 is torn.

FIG. 8 is a drawing showing a cross-sectional configuration of an airbag cover 200 according to another embodiment showing the same portion as FIG. 6.

FIG. 9 is a drawing showing a cross-sectional configuration of an airbag cover 300 according to another embodiment showing the same portion as FIG. 6.

### DETAILED DESCRIPTION

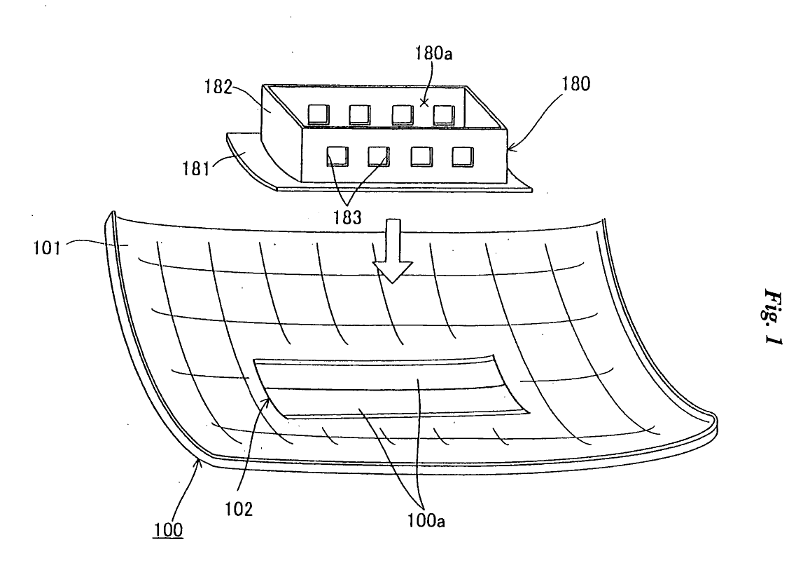

Referring now to the drawings, an embodiment of the present invention will be described. First, the configuration of an airbag cover 100 will be described with reference to FIGS. 1 to 6.

FIG. 1 is a perspective view showing a state of the airbag cover 100 according to an embodiment of the present invention when viewed from a back surface 101 of the cover.

As shown in FIG. 1, there is a tear line 102 formed on the back surface 101 of the airbag cover 100 for covering the vehicle's airbag. The airbag cover 100 has a plate shape formed three-dimensionally (solid shape) of resin material, such as PP (Polypropylene) material, TPO (Thermoplastic Elastomer Polyolefin), or the like. The back surface 101 of the airbag cover 100 is defined as a surface on the backside when the side of the airbag cover 100 facing an occupant in a state in which the airbag cover 100 is installed is assumed to be a front surface.

The tear line 102 is a thinned portion provided for allowing the deployment of the airbag cover 100 upon deployment and inflation of the vehicle's airbag. In the present embodiment, it is provided by a linear groove formed on the back surface 101 of the airbag cover. The tear line or linear grove 102 is defined as a linear thinned portion which has smaller wall thickness with respect to the wall thickness of the respective portions of the airbag cover 100.

According to an embodiment of the present invention, the airbag cover 100 is torn along the tear line 102 upon deployment and inflation of the vehicle's airbag, and a pair of open-out door panels 100a are adapted to open toward the front side of the cover like double doors (like casement doors). The airbag cover 100 is configured to break along the tear line 102, so that the open-out door panel 100a opens toward the front side or cabin side of the airbag cover 100.

As shown in FIG. 1, am embodiment of the present invention may be configured such that a storage member 180 is joined to the back surface 101 of the airbag cover 100 at the position corresponding to the opening of the open-out door panel 100a. The storage member 180 may include a base portion 181 to be joined to the back surface 101 of the airbag cover 100 so as to oppose thereto, and a leg member portion 182 projecting upright from the base portion 181 in the direction away from the open-out door panel 100a. The portion of the leg member 182 projecting upright is formed with a plurality of openings 183, and the openings 183 are used for engaging hooking members 172 used when mounting a retainer 170 which will be described later to the storage member 180. In other words, the retainer 170 is adapted to be attachable and detachable to the storage member 180 via the hooking members 172. The storage member 180 forms a storage space 180a in the area defined by the base portion 181, the leg member 182, and the retainer 170 which will be described later. Therefore, in a state in which the retainer 170 is mounted to the storage member 180, the vehicle's airbag 150 is stored in the storage space 180a, and the vehicle's airbag 150 is covered by the airbag cover 100 from the cabin side.

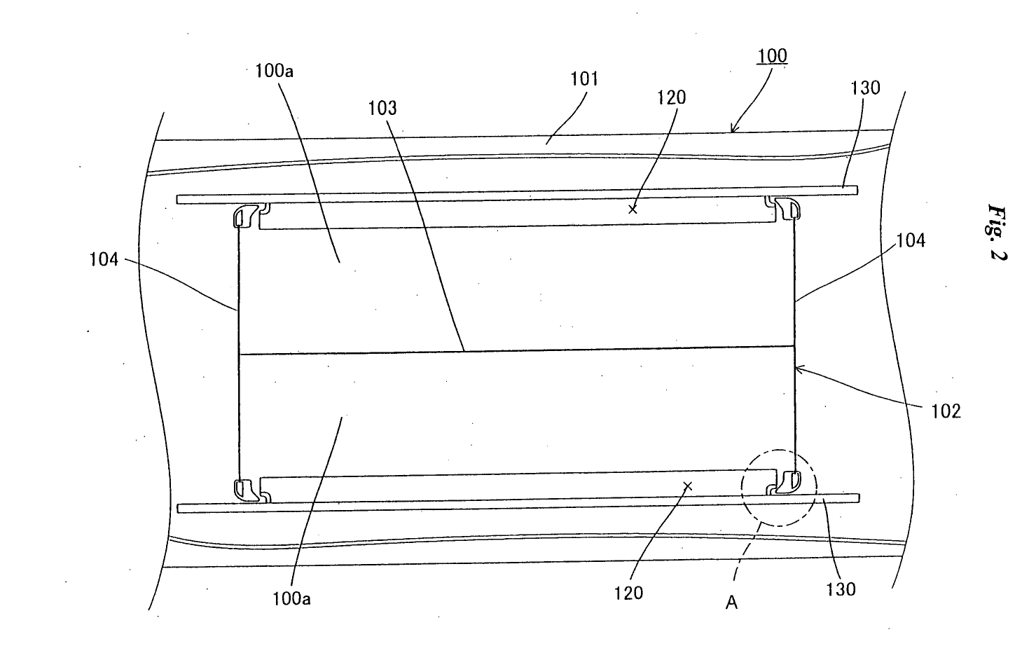

As shown in FIG. 2, which shows a top view of the portion in the vicinity of the tear line 102 in FIG. 1, the tear line 102 includes a first linear groove 103, and two second linear grooves 104 in combination, and shaped substantially like a letter H as a whole in plan view. The first linear groove 103 extends linearly in the lateral direction in FIG. 2, and the second linear grooves 104 extend linearly in the vertical direction in FIG. 2 at both ends of the first linear groove 103 (direction orthogonal to the first linear groove 103).

On the back surface 101 of the airbag cover 100, at the positions where the two second linear grooves 104 opposes, thinned portions 120 extending in parallel to the first linear groove 103 are provided on both sides of the first linear groove 103. On the outsides of the thinned portions 120, there are provided second ribs 130 projecting upright on the back surface 101 of the airbag cover 100 along the direction in which the thinned portions 120 extend.

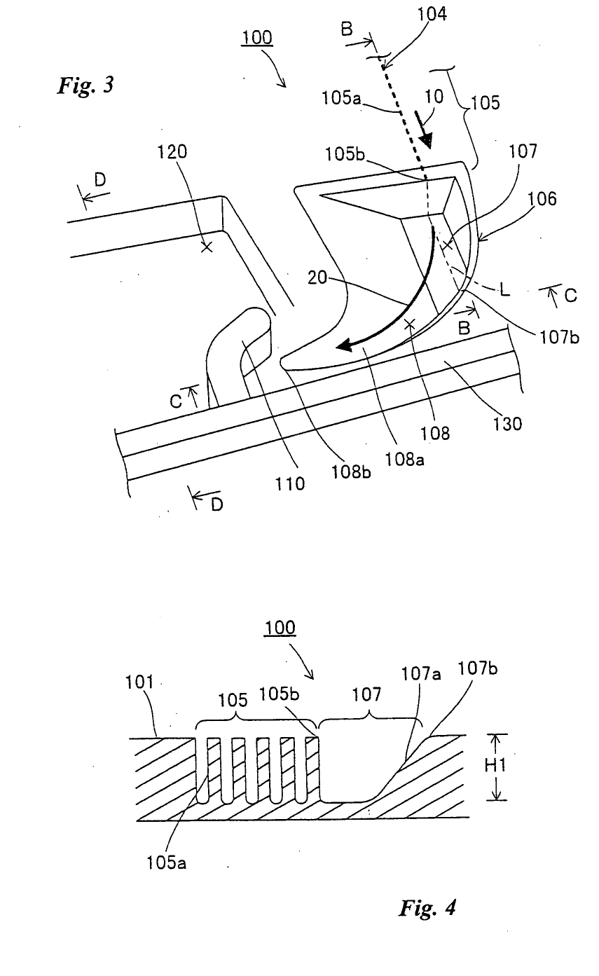

Referring now to FIG. 3 to FIG. 6, the detailed configuration of the portion “A” in FIG. 2 of the airbag cover 100 will be described. The portion “A” is formed at both end areas of the second linear grooves 104, that is, four locations (four corners) on a tear line 102.

An enlarged drawing of the portion “A” in FIG. 2 is shown in FIG. 3, which depicts, among other things, a laser cut groove 105 formed at the end area of the second linear groove 104. The laser cut groove 105 is constructed of dot shaped holes 105a (depth of the hole H1) formed by laser cut so as to extend discontinuously. In other words, recesses and projections defined by the holes 105a are alternately repeated in the direction in which the laser cut groove 105 extends.

As shown in FIG. 3, in the area of the end 105b of the laser cut groove 105 (end area of the second linear groove 104), a recess 106 is formed on the extension of the laser cut groove 105. In other words, the area of the end 105b of the laser cut groove 105 is provided with a construction combining the laser cut groove 105 and the recess 106 (hybrid construction). The recess 106 includes a first recess 107 and a second recess 108.

The first recess 107 extends from the area of the end 105b of the laser cut groove 105 in the direction along an extension L of the laser cut groove 105 (the direction indicated by an arrow 10 in FIG. 3). The second recess 108 is extended in the direction intersecting with the direction along the extension L of the laser cut groove 105 (the direction toward a first rib 110 and the thinned portion 120).

As shown in FIG. 4 (which shows a cross-sectional configuration taken along the line B-B), the first recess 107 has a depth H1 which is equivalent with the depth H1 of the hole 105a of the laser cut groove 105, and includes a bevel 107a on the side of the end 107b thereof. The depth of the recess in the direction of the thickness of the bevel 107a (depth of thinning) reduces gradually at a constant ratio from the side of the laser cut groove 105 as it gets closer to the end 107b (as it gets away from the end 105b of the laser cut groove 105).

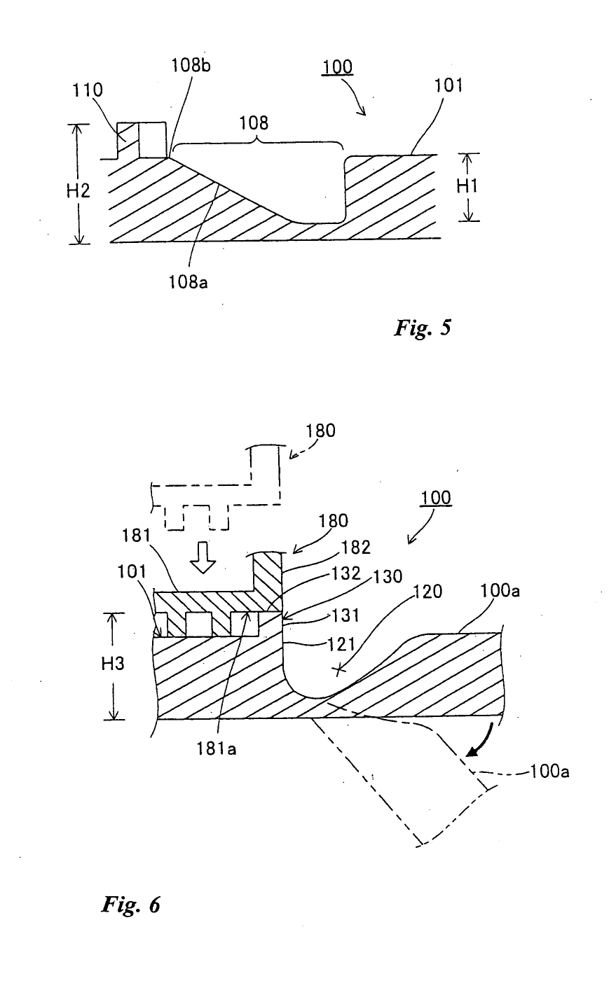

As shown in FIG. 5 (which shows a cross-sectional configuration taken along the line C-C in FIG. 3), the second recess 108 has a depth H1 which is equivalent to the depth H of the hole 105a of the laser cut groove 105, and further has a bevel 108a. The depth of the bevel 108a in the direction of the thickness (depth of thinning) reduces gradually at a constant ratio from the first recess 107 as it gets closer to the end 108b (as it gets away from the bevel 107a).

The width of the groove of the second recess 108 in plan view reduces gradually as it gets closer to the end 108b.

In the embodiments depicted by FIG. 3 and FIG. 5, the first rib 110 is provided on the extension from the first recess 107 to the second recess 108. The first rib 110 is a rib which has a height expanding the thickness of the airbag cover 100 (height shown by H2 in FIG. 5). The first rib 110 is recessed on the side of the end 108b of the second recess 108 in plan view, and is constructed to surround the end 108b.

As shown in FIG. 6 (which shows a cross-sectional configuration taken along the line D-D in FIG. 3), the thinned portion 120 is formed in the boundary area between the main body of the airbag cover and the open-out door 100a of the airbag cover on the back side 101. The thinned portion 120 corresponds to the thinned portion (portion to which mass-removal is done), and is depressed from the back surface 101 of the cover toward the front surface. The thinned portion 120 facilitates bending action of the open-out door panel 100a in the direction indicated by an arrow in the drawing. The thinned portion 120 allows the opening action of the open-out door panel 100a toward the cabin side. In other words, the thinned portion 120 constitutes a hinge mechanism (hinge mechanism) of the open-out door panel 100a working when the open-out door panel 100a of the airbag cover 100 is torn along the tear line 102 and opened.

A second rib 130 is provided between the main body of the airbag cover and the open-out door panel 100a of the airbag cover 100 at the position continuing from the thinned portion 120 of the above-described configuration. The second rib 130 is a projection projecting (projecting upright) from the back surface 101 of the cover in the direction opposite to the cabin, and has a configuration extending in the direction intersecting, that is, in FIG. 6, in the direction orthogonal to, the extending surface in which the open-out door panel 100a extends. The second rib 130 is disposed so that a side surface 131 extends along an upright surface 121 of the thinned portion 120 when the airbag cover 100 and the storage member 180 are joined to each other by a joining method described later. The second rib 130 and the portion of the main body of the airbag cover at which the second rib 130 is provided may combine to form an extending portion.

According to an embodiment of the present invention, the extending length of the extending portion where the second rib 130 is provided, that is, the length obtained by adding the projecting height of the second rib 130 to the wall thickness of the main body of the airbag cover (the height shown by H3 in FIG. 6) may be configured to be larger than the wall thickness at the respective portion on the side of the open-out door panel 100a with respect to the second rib 130. Therefore, by the cooperation of the thinned portion 120 and the second rib 130 continuing from the thinned portion 120, the position of the hinge of the open-out door panel 100a is clearly defined between the main body of the airbag cover and the open-out door panel 100a. Here, the second rib 130 has a function to clearly define the position of the hinge of the open-out door panel 100a. The second rib 130 and the thinned portion 120 may combine to form a hinge mechanism.

When manufacturing the airbag cover 100 in the configuration described above, a molded article on which the tear line 102 is not formed, for example, a plate-shaped molded article formed three-dimensionally, is manufactured first. When molding such molded article, the above-described recess 106, the first rib 110, the thinned portion 120, and the second rib 130 are molded together. Subsequently, the molded body is formed with the tear line 102 by after-processing (in this embodiment, laser cut using a laser cut machining equipment). Consequently, the airbag cover 100 of above-described configuration is obtained. In this manner, by providing the tear line 102 using laser cut as the after-processing, the problem of so-called molding sink is solved and thus the appearance is improved. While the molding sink may be generated when an attempt is made to provide a hinged portion without providing a thinned portion such as the thinned portion 120, when the improved thinned portion 120 disclosed herein is provided, the hinged portion can be formed without generating the molding sink.

Subsequently, the storage member 180 is joined to the airbag cover 100. In this case, firstly, the storage member 180 is placed on the back surface 101 of the airbag cover 100 as sown in FIG. 6, and the bottom surface 181 a of the base portion 181 of the storage member 180 is brought into abutment with the back surface 101 of the airbag cover 100. In particular, the horizontal portion of the bottom surface 181a of the base portion 181 is brought into abutment with the upper surface 132 of the second rib 130. Then, the storage member 180 is joined to the airbag cover 100 side by welding (e.g., using a welding method such as vibration welding (a method of providing vibrations to a resin part to be joined and welding and joining the same with friction energy)). Accordingly, the back surface 101 of the airbag cover 100 and the bottom surface 181a of the base portion 181 of the storage member 180 are joined with each other. At this time, in particular, the portion which corresponds to the root of the open-out door panel 100a is positively fixed to the storage member 180 by the upper surface 132 of the second rib 130 continued from the thinned portion 120 joined to the bottom surface 181 a of the base portion 181. The second rib 130 here has both a first function to clearly define the position of the hinge of the open-out door panel 100a and a second function as the joint rib. In this manner, the airbag cover 100 having a storage member 180 may be provided.

According to various embodiments of the present invention, the second rib 130 may be an integral part of the airbag cover 100, as shown in FIG. 6, or may instead be an integral part of the storage member 180. Still further, other embodiments of the invention may utilize a rib 130 that is separate from the storage member 180 and the airbag cover 100. Still further, other embodiments may have a bifurcated rib, where a first portion of the rib is integral with the airbag cover 100 and a second portion of the rib is integral with the storage member 180.

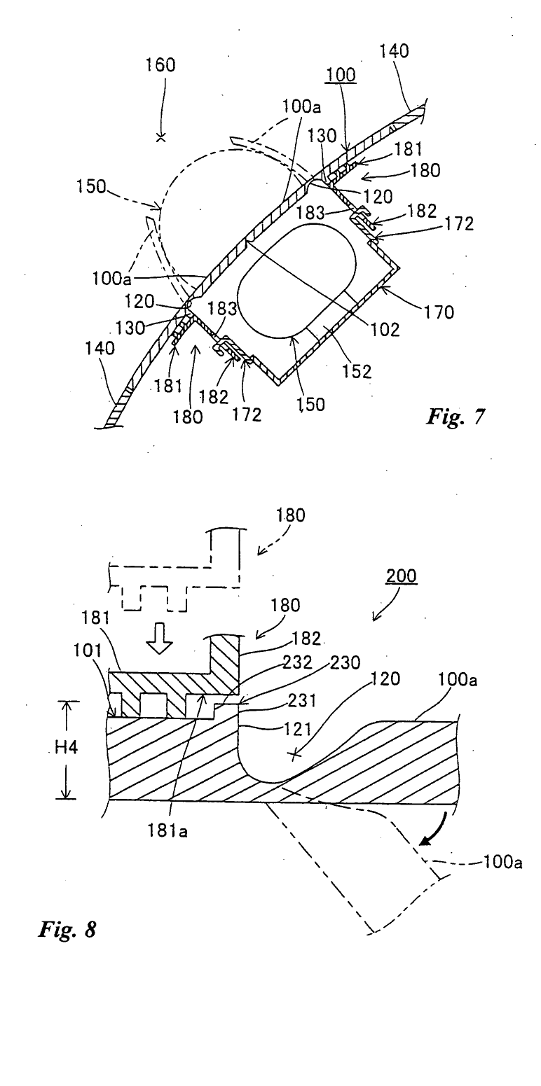

After placing the airbag cover 100 with the storage member 180, the retainer 170, in which the vehicle's airbag 150, gas feeding mechanism (inflator) 152 are stored, is mounted to the airbag cover 100 having the storage member 180. A method of mounting the retainer 170 to the airbag cover 100 will be described referring to the configuration of the airbag module shown in FIG. 7. FIG. 7 shows a cross-sectional view of the configuration of the airbag module, showing a state in which the airbag cover 100 is torn.

As shown in FIG. 7, the airbag module includes the airbag cover 100 provided with the storage member 180, an instrument panel 140 in which the airbag 100 is disposed, the vehicle's airbag 150, the retainer 170 in which the vehicle's airbag 150 is stored in a folded state, a gas feeding mechanism (inflator) 152 integrated in the retainer 170 for feeding inflating gas to the vehicle's airbag 150.

Hooking member 172 is secured to the retainer 170, and the retainer 170 is mounted to the airbag cover 100 via the storage member 180 by engaging the hooking members 172 with the openings 183 on the storage member 180. In a state in which the retainer 170 is mounted to the storage member 180 via the hooking members 172, the vehicle's airbag 150 is stored in the storage space 180a. In this manner, according to an embodiment of the present invention, the storage member 180 joined to the airbag cover 100 is a member for storing the vehicle's airbag 150 by mounting the retainer 170 to the storage member 180. According to an embodiment of the present invention, a storage member may include both the retainer 170 and the storage member 180.

Referring now to FIG. 3, FIG. 6, and FIG. 7, the operation of the airbag cover 100 configured as described above will be described.

In the case of front collision of the vehicle, the gas feeding mechanism 152 is activated and the vehicle's airbag 150 is deployed by the inflation gas supplied from the gas feeding mechanism 152. The airbag cover 100 is torn along the substantially H-shaped tear line 102 upon deployment and inflation of the vehicle's airbag 150, and a pair of open-out door panel 100a are brought into deployment like double doors (like casement doors) toward the front surface of the cover.

At this time, the second linear groove 104 is torn along the laser cut groove 105 in the direction indicated by the arrow 10 in the drawing as shown in FIG. 3. Here, since the laser cut groove 105 is formed of holes 105a extending discontinuously and thus recesses and projections defined by the holes 105a are alternately repeated, when the laser cut groove 105 is torn entirely to the end 105b, a force that attempts to tear linearly along the extension L tends to be concentrated to the portion on the extension in the area around the end 105b. In such a case, a tearing phenomenon referred to as so-called “tearover” may occur along the extension L on the portion including the extension L at the end 105b of the laser cut groove 105.

Therefore, according to an embodiment of the present invention, the recess 106 is provided on the extension of the laser cut groove 105 in addition to the laser cut groove 105, as shown in FIG. 3. The recess 106 is effective for gradually dispersing the force that attempts to generate tearover along the extension L of the laser cut groove 105 and preventing the force generated when being torn is prevented from concentrating to the area around the end 105b of the laser cut groove 105. In other words, the force exerted to the area of the end 105b of the laser cut groove 105 when the airbag cover 100 is torn is dispersed (absorbed) gradually at the bevel 107a of the first recess 107, and is attenuated as it gets closer to the end 107b. Accordingly, the tearing operation of the airbag cover 100 can be preferably controlled.

Also, according to an embodiment of the present invention, as shown in FIG. 3, the second recess 108 extending from the first recess 107 to the first rib 110 is provided on the recess 106. Therefore, the force that attempts to tear linearly the portion along the extension L of the laser cut groove 105 may be dispersed by the first recess 107, and then the force may further be dispersed in the directions different from the direction of the extension L of the laser cut groove 105 by the second recess 108 (the direction indicated by an arrow 20 in FIG. 3). Specifically, according to an embodiment of the present invention, since the depth of the second recess 108 (depth of thinning) and the width of the groove in plan view are gradually reduced as it gets closer to the end 108b, the force exerted on the area of the end 105b of the laser cut groove 105 is dispersed not only in the direction of the depth, but also in the direction of width when the airbag cover 100 is deployed, and thus the effect of dispersion of the force is assured. Therefore, the tearover (that is, a phenomenon in which the torn portion extends beyond the laser cut groove 105 by energy or force applied when tearing) may be effectively prevented from occurring on the portion including the extension L of the laser cut groove 105 of the airbag cover 100.

In addition, according to an embodiment of the present invention, the first rib 110 may receive the force dispersed in the direction toward the first rib 110 by the second recess 108. Accordingly, even when a tear is formed from the first recess 107 to the second recess 108, a tear is prevented from being formed on the side of the first rib 110 opposite from the recess 106 by the first rib 110.

In this manner, the pair of open-out door panels 100a of the airbag cover 100 becomes deployed toward the cabin side (the front surface of the cover) as the tear line 102 is torn. At this time, the torn portions (end areas of the second linear grooves 104) on both sides of the respective open-out door panels 100a (the end area of the second linear groove 104) extend from both sides of the open-out door panels 100a inwardly by the effect of the recess 106 constructed as described above. Such construction is especially effective to improve feasibility of opening of the respective open-out door panels 100a. As shown in FIG. 7, the vehicle's airbag 150 is deployed toward the outside of the airbag cover 100 through the open-out door panels 100a in the deployed state, and projects toward an occupant crash protection area 160 defined in front of the occupant into the inflated and deployed state.

According to an embodiment of the present invention, when the vehicle's airbag 150 is deployed and inflated, and the open-out door panel 100a are opened, since the position of the hinge relating to the opening action of the open-out door panel 100a is clearly defined by the thinned portion 120 and the second rib 130 as shown in FIG. 6, formation of the position of the hinge at the unexpected position as a result of generation of forced bent in the boundary area between the main body of the airbag cover and the open-out door 100a is avoided, and formation of the position of the hinge exactly at the designed position is achieved. Since the load applied on the position of the hinge when the vehicle's airbag 150 is deployed and inflated, and hence the open-out door panel 100a is deployed may be received by the portion including the second rib 130, that is, by the portion having a larger wall thickness, the strength of the airbag cover 100 may be increased.

Since the thinned portion 120 continuing from the second rib 130 is provided, the open-out door panel 100a can be bent easily at the position of the hinge, consequently, the hinge effects increase.

21 Furthermore, since the second rib 130 continuing from the thinned portion 120 is joined to the bottom surface 181 a of the base portion 181 of the storage member 180, the portion corresponding to the root of the open-out door panel 100a is positively fixed, and hence the opening action of the open-out door panel 100a can be smoothly performed.

In this manner, the second rib 130 according to an embodiment of the present invention is rational since it has the first function for clearly defining the position of the hinge when the open-out door panel 100a opens and the second function for positively joining the airbag cover 100 and the storage member 180.

The height (projecting height) of the second rib 130 may be established so that the rib 130 does not impair the appearance of the cover. While the second rib 130 is projected upright on the back surface 101 of the airbag cover 100, a configuration in which another rib is provided on the front surface of the airbag cover 100 at the position corresponding to the second rib 130 can also be employed. With such a configuration, the opening action of the open-out door panel 100a can further be stabilized by balancing between the second rib 130 and the above-described another rib.

The present invention is not limited to the embodiments described above, and various applications or modifications may be considered. For example, the following embodiments in which the above-described embodiment is applied may be implemented.

In the above-described embodiment, the case in which the position of the hinge relating to the opening action of the open-out door 100a is defined by the thinned portion 120 and the second rib 130 has been described. However, the configuration of the position of the hinge can be modified variously as needed.

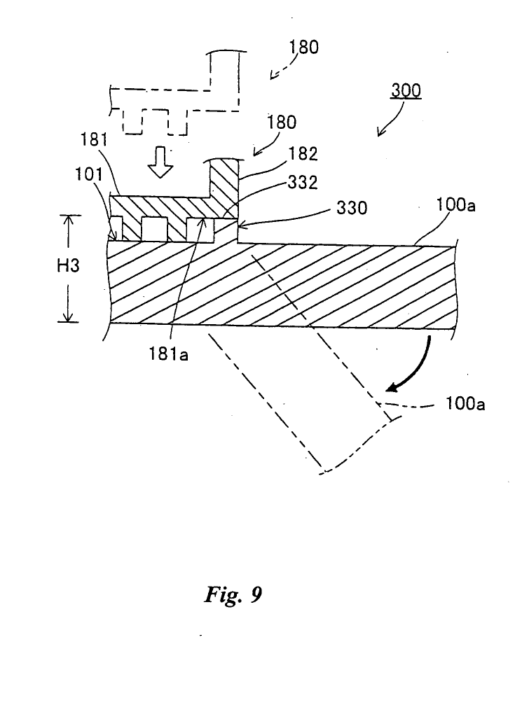

Referring now to FIG. 8 and FIG. 9, a configuration of the airbag cover of another embodiment will be described. In FIG. 8 and FIG. 9, the same components as those shown in FIG. 6 are designated by the same reference numerals, and detailed description about those components is omitted.

FIG. 8 shows a cross-sectional configuration of an airbag cover 200 of another embodiment showing the same portion as in FIG. 6.

According to the airbag cover 200 shown in FIG. 8, when the airbag cover 100 and the storage member 180 are joined to each other, the upright surface of the thinned portion 120 is disposed so as to extend along the side surface 231 of the second rib 230. Then, the upper surface 232 of the second rib 230 of the airbag cover 200 does not abut against the bottom surface 181a of the base portion 181 of the storage member 180. In other words, while the second rib 130 is adapted to serve as the joint rib by abutment of the upper surface 132 of the second rib 130 against the bottom surface 181a of the base portion 181 of the storage member 180 according to the airbag cover 100, the second rib 230 of this embodiment does not have a function as the joint rib. With the second rib 230 having such a configuration as well, it is also possible to form the position of the hinge at least exactly at the designed position by the cooperation with the thinned portion when the open-out door panel 100a opens. In addition, it achieves such effect that the open-out door panel 100a can easily be bent at the position of the hinge, so that the effect of the hinge is improved.

FIG. 9 is a cross-sectional view of the airbag cover 300 according to another embodiment, showing the same portion as FIG. 6.

According to the airbag cover 300 shown in FIG. 9, the wall thickness between the second rib 230 and the open-out door panel 100a is the same as the wall thickness of the open-out door panel 100a itself. In other words, the airbag cover 300 may not have a thinned portion as the thinned portion 120 formed on the airbag cover 100. The upper surface 332 of the second rib 330 of the airbag cover 300 abuts against the bottom surface 181a of the base portion 181 of the storage member 180, and serves as joint rib. With the second rib 330 of such configuration as well, the position of the hinge can be formed exactly at the designed position when the open-out door panel 100a opens. Furthermore, since the portion which corresponds to the root of the open-out door panel 100a is positively fixed via the second rib 330, such effect that opening action of the open-out door panel 100a can be smoothly performed as designed is achieved. It is also possible to employ a configuration in which the upper surface 332 of the second rib 330 does not abut against the bottom surface 181 a of the base portion 181 of the storage member 180 in FIG. 9. With such a configuration, the hinge can be formed at least exactly at the designed position when the open-out door panel 100a opens.

While the case in which the retainer 170 in which the vehicle's airbag 150 is stored is mounted to the storage member 180 joined to the airbag cover 100 via the hooking members 172 has been described in the above-described embodiments, such configuration that a member corresponding to the retainer 170 is directly joined to the airbag cover 100 without using the member corresponding to the storage member 180 may be also be employed.

While the case in which vibration welding is used for welding and joining the storage member 180 to the airbag cover 100 side has been described in the above-described embodiment, other welding methods, such as ultrasonic wave welding (a method of melting and joining by applying ultrasonic vibration to a resin part to be joined), heat plate welding (a method of melting resin by bringing it into contact with a heat source (heat plate) and joining it before the melted portion is cooled and hardened) may be employed.

The present application claims priority to Japanese Patent Application Nos. 2003-3310 filed on Sep. 04, 2003, the contents of these applications are incorporated herein by reference in their entirety

Given the disclosure of the present invention, one versed in the art would appreciate that there may be other embodiments and modifications within the scope and spirit of the present invention. Accordingly, all modifications attainable by one versed in the art from the present disclosure within the scope and spirit of the present invention are to be included as further embodiments of the present invention. The scope of the present invention accordingly is to be defined as set forth in the appended claims.

1. An airbag module comprising:
a cover including a main body for covering a vehicle's airbag from the cabin side; wherein the main body includes a linear groove having a depth within the limit of the wall thickness of the airbag cover;
a door adapted to open toward the cabin side upon tearing of the linear groove; and
a hinge mechanism configured to allow the door to open toward the cabin;
wherein the hinge mechanism includes an extending portion extending away from the main body of the cover in a direction away from the cabin, wherein the extending portion is located between the door and the main body of the airbag cover.

2. The module of claim 1, wherein the thickness of the door is thinner adjacent to the extending portion than at other portions of the door.

3. The module of claim 1-, further comprising a storage member for storing an airbag, wherein the extending portion abuts against and is joined to the storage member.

4. The module of claim 2, further comprising a storage member for storing an airbag, wherein the extending portion abuts against and is joined to the storage member.

5. The module of claim 3, wherein the storage member includes a rib that contacts the extending portion of the cover.

6. The module of claim 3, wherein the extending portion includes a rib that contacts the storage member.

7. The module of claim 3, wherein the storage member and the cover are welded together.

8. A cover for an airbag comprising:
a main body including a linear groove;
an open-out door adapted to open away from the airbag toward the cabin of a vehicle upon tearing of the groove; and
a hinge mechanism adapted to allow an opening action of the open-out door toward the vehicle cabin;
wherein the hinge mechanism includes an extending portion extending away from the main body of the cover in a direction away from the cabin, wherein the extending portion is located between the open-out door and the main body of the airbag cover and the open-out door; and wherein the thickness of the cover at the extending portion is greater than the thickness of the door.

9. The cover of claim 5, wherein the thickness of the door is thinned adjacent to the extending portion with respect to wall thickness at other portions of the open-out door.

10. The cover of claim 5, wherein the cover is adapted to be connected to an airbag storage member, wherein the extending portion is located to be joined with the storage member so that the extending portion abuts against the storage member and is adapted to be used as a joint rib.

11. An airbag module comprising:
an airbag and a cover for the airbag including a linear tear line; wherein the cover is configured to break apart at the tear line when the airbag inflates;
wherein the cover includes thinned portions extending substantially parallel to the tear line thereby forming a hinge mechanism allowing the cover to separate into doors that swing away from the airbag as the airbag inflates;
wherein the module includes an extending portion adjacent the thinned portion and located on the opposite side of the thinned portion from the tear line;
wherein the thickness of the extending portion is greater than the thickness of the cover adjacent the tear line.

12. The airbag module of claim 11, further comprising an airbag storage member connected to the cover at the extending portion.

13. The airbag module of claim 12, wherein the extending portion includes a rib on the storage member.

14. The airbag module of claim 12, wherein the extending portion includes a rib on the cover.

15. The airbag module of claim 11, further comprising an airbag storage member connected to the cover.

16. The airbag module of claim 15, wherein the extending portion includes a rib on the cover.

17. The airbag module of claim 16, wherein the cover and storage member are connected so that the rib does not contact the storage member.
